(19) United States
(12) Patent Application Publication
(10) Pub. No.: US 2005/0018752 A1
(43) Pub. Date: Jan. 27, 2005

(54) Chirping digital wireless system

(76) Inventor: Richard L. Anglin JR., Del Mar, CA (US)

Correspondence Address: Thomas N. Giaccherini, Post Office Box 1146, Carmel Valley, CA, 93924, US

(21) Appl. No.: 10/860,514

(22) Filed: Jun. 2, 2004

Related U.S. Application Data
(63) Continuation-in-part of application No. 09/212,339, filed on Dec. 15, 1998, now abandoned.
(63) Continuation-in-part of application No. 10/261,195, filed on Sep. 30, 2002, now abandoned.
(63) Continuation-in-part of application No. 09/344,086, filed on Jun. 25, 1999, now abandoned.
(63) Continuation-in-part of application No. 09/620,101, filed on Jul. 20, 2000, now abandoned.
(63) Continuation-in-part of application No. 08/943,987, filed on Oct. 3, 1997, now abandoned.
(63) Continuation-in-part of application No. 10/633,147, filed on Aug. 1, 2003.

(51) Int. Cl. H04B 1/69

(52) U.S. Cl. 375/139

(57) ABSTRACT

The present invention includes a chirp transmission means for generating and emanating chirps. In general, a chirp is a pulse, waveform or propagated signal which may be characterized by a mathematical function. In one embodiment, the mathematical function comprises a relationship between frequency and time. The invention also includes a chirp reception means for receiving chirps without the need for tuning to a carrier waveform. The reception means is capable of extracting digital data from the received chirps. In alternative embodiments of the invention, the chirps may convey voice, video or other signals.

### CROSS-REFERENCE TO RELATED PATENT APPLICATIONS & CLAIMS FOR PRIORITY

The present patent application is a Continuation-in-Part patent application based on:
U.S. patent application Ser. No. 09/212,339 filed on 15 Dec. 1998 (Chirp One—first of two);
U.S. patent application Ser. No. 10/261,195 filed on 30 Sep. 2002 (Chirp One—second of two);
U.S. patent application Ser. No. 09/344,086 filed on 25 Jun. 1999 (Chirp Two—first of two);
U.S. patent application Ser. No. 09/620,101 filed on 20 Jul. 2000 (Chirp Two—second of two);
U.S. patent application Ser. No. 08/943,987 filed on 3 Oct. 1997 (Chirp System—first of two); and
U.S. patent application Ser. No. 10/633,147 2003 filed on 1 Aug. 2003 (Chirp System—second of two).

The Applicant claims the benefit of priority under Sections 119 & 120 of Title 35 of the U.S. Code of Laws for any and all subject matter which is commonly disclosed in the present Application, and in all the other Applications listed above.

### FEDERALLY SPONSORED RESEARCH OR DEVELOPMENT

Not Applicable.

### FIELD OF THE INVENTION

The present invention relates to the field of digital communications. More particularly, this invention provides novel methods and apparatus for broadcasting wireless digital data to mobile, portable and fixed receivers and for receiving digital transmissions from those user terminals using frequency chirps to create a transmitted waveform with a binary or alphanumeric or special character data structure. Utilization of the present invention will enable efficient high bandwidth digital wireless communications leading to new markets for interactive wireless communications services, including voice, data, image, compressed video and Internet access.

### BACKGROUND OF THE INVENTION

Wireless communication systems such as cellular, Personal Communication System (“PCS”) and satellite systems such as Iridium and American Mobile Satellite Corporation (“AMSC”) have all been implemented and deployed to enable mobile voice communications. Technologies for these systems, whether analog or digital, have evolved from the voice handling requirements of the Public Switch Telephone Network (“PSTN”). Virtually all of these systems are narrowband because of the limited radio frequency (“RF”) spectrum available to each service. The channels are sized to the minimum bandwidth required to support “acceptable” voice communications. “Acceptability” means intelligibility and clarity, not necessarily the “toll” quality of the PSTN. All of these systems are symmetric, that is, two channels of equal size are required to support full-duplex voice communications.

The system parameters that are required to deliver voice services make handling digital data communications difficult. All of these systems accommodate wireless digital data communications, but the data throughput rates are very low and the additional equipment required can be complex because of the network switching requirements.

The advent of the Internet has ushered a fundamental paradigm shift in the way in which information is collected, stored, displayed, accessed and distributed. The Internet has taken over, with the Web browser rapidly becoming the user template for communications, information and even entertainment. This feature-rich multimedia environment has led to bandwidth demands which traditional wireline telecommunications networks struggle today to meet.

For example, information formerly presented in catalogs resides in World Wide Web (“WWW” or “Web”) sites and is available for viewing via a Web browser, printing to a local printer or downloading as a file to a local personal computer (“PC”). Electronic mail (“e-mail”) has become the de rigeur for business and is widely used by consumers.

The historical model of centralized corporate information databases has been replaced by dispersed local servers interconnected via high-speed telecommunications networks. The increasing mobility and globalization of business requires virtually instantaneous access to this information wherever it may reside. Mobile workers are expected to have the same access as workers in fixed locations. Go to any major airport in the world and observe countless travelers toting laptop PCs. In seeking to make waiting time productive they are constantly looking for data ports to plug in their laptops to access the Internet.

Wireless communications carriers, terrestrial and satellite, are today seeking technologies to support this major paradigm shift to the Internet. They are constrained, however, by the narrowband, low speed, symmetrical character of deployed wireless communication systems.

Eavesdrop on any conversation about the Internet and the topic of access speed invariably comes up. The great majority of people are talking about access speed at their business or home. Access speed is addictive. Once having access to higher Internet speeds, users resist, often to the point of avoidance, lower speed technologies (even for just e-mail). When it comes to wireless Internet access there are no high speed alternatives.

Consider a typical mobile Internet session. The user logs onto the Internet and first requests download of his or her e-mail messages. The request to the electronic mail server is a very small message. The download can be quick if there are only a few messages and the messages themselves are small. However, if there are a large number of messages or the messages contain a large amount of text, downloading can take a very long time. Downloads are even slower if the messages have files appended to them, and slower still if the files are graphic images or video.

This user is a corporate salesperson and needs to download a product brochure. Again, the request to the database server is a small message, but the download file is large. The download process maybe extremely slow if the file contains embedded images in color.

There is a tremendous and rapidly increasing need for a wireless communication system to support high speed mobile digital data communications. The desired system should be asymmetric; providing high bandwidth for downloading information and small bandwidth for uploading message requests and electronic mail. However, high bandwidth should also be available if the user needs to upload a large file. Thus, the desired wireless digital data communications system should be able to dynamically allocate bandwidth to users to accommodate their particular requirements at any given point in time.

### SUMMARY OF THE INVENTION

The Chirping Digital Wireless System provides high speed, asymmetric, dynamically allocated wireless digital data communications capacity to mobile and fixed users. The present invention includes a chirp transmission means for generating and emanating chirps. In general, a chirp is a pulse, waveform or propagated signal which may be characterized by a mathematical function. In one embodiment, the mathematical function comprises a relationship between frequency and time. The invention also includes a chirp reception means for receiving chirps without the need for tuning to a carrier waveform. The reception means is capable of extracting digital data from the received chirps. In alternative embodiments of the invention, the chirps may convey voice, video or other signals.

An appreciation of the other aims and objectives of the present invention and a more complete and comprehensive understanding of this invention may be obtained by studying the following description of a preferred embodiment and by referring to the accompanying drawings.

### A BRIEF DESCRIPTION OF THE DRAWINGS

FIG. 1 shows linear frequency chirps.

FIG. 2 shows a progression of linear frequency up-chirps and down-chirps in time-frequency space.

FIG. 3 shows a progression of linear frequency up-chirps and down-chirps in time-field strength space.

FIG. 4 shows non-linear frequency chirps.

FIG. 5 shows a functional block diagram of the Chirping Digital Wireless System.

FIG. 6 shows a functional block diagram of a chirping transmitter system.

FIG. 7 shows a functional block diagram of a chirping receiver system.

### A DETAILED DESCRIPTION OF PREFERRED & ALTERNATIVE EMBODIMENTS

Overview of the Invention

A “chirp” is generally defined as a waveform or propagated signal which may be characterized by a mathematical function. In one embodiment of the invention, the mathematical function is a relationship between the frequency of the chirp and time. The chirp interval (“T”) is defined as the time between the beginning of one chirp and the beginning of the succeeding chirp.

Impression of a digital structure to such a signal can be accomplished by defining a binary one (1) to be an up-chirp and a binary zero (0) to be a down-chirp, or vice versa. A digital signal can then be sent using a stream of up- and down-chirps. The data rate for the digital stream is determined by the time between the start of successive chirps. Very high data rates can be achieved with today's semiconductor technology.

The receiver of the information only needs to determine if the chirp being received is up or down to determine if the signal being sent is a binary one or a binary zero. This means that a great deal of dispersion and noise can be tolerated in conjunction with the signal.

Similarly, alternative chirp forms, that is, non-linear chirps, can be used to define binary, alphanumeric or specialized characters. Multiple transmissions are thus enabled in the same waveform by using alternative chirp modes.

Dead time between the chirps is not necessary, but would allow such strategies as range and/or time gating at the receiver, for example, using differential Global Positioning System (“GPS”) for receiver location. This would eliminate the multiple path problem in urban environments and make reception of weaker and/or nosier signals more reliable.

Dead time between pulses and directional antennas also make possible broadcast of multiple signals on the same frequency band, thus increasing the potential number of communications in a particular frequency band.

Time spacing and duration of the chirps determines not only the throughput of the system but the difficulty and expense in building a wireless communications system based upon these principles. The system can initially be built with large spacing and long pulses and both can be shortened as the system matures and more throughput is required. Additionally, multiple sub-bands can be established and the chirps broadcast within the sub-bands.

The disclosed invention is fundamentally different from existing wireless communications systems. Whether analog or digital, whether coded or packetized, all existing wireless communications systems rely upon voltage pulses for the transmission of information. The disclosed invention utilizes pure frequency pulses for the transmission of information; no carrier waveform is required (although their use may be beneficial for various technical reasons).

The present invention offers a number of synergies and advantages. First, all existing two-way mobile communications technologies are narrow-band, fixed bandwidth and symmetrical, that is, out-bound and in-bound channels are of equal size. The disclosed invention can be asymmetrical, the out-bound transmission to the mobile user much higher in bandwidth than the in-bound channel. Further, the out-bound bandwidth can be variable; it can be tailored to meet service requirements. Further, both the out-bound and in-bound bandwidth can be allocated dynamically, that is, allocated in time in response to user demand. For example, more bandwidth can be allocated to download a Web page than is required to request a particular Web page.

Second, the disclosed invention can be used for reliable communications in a multipath and radio frequency (“RF”) noisy environment. Transmission integrity may be maintained in an environment of interference from other transmissions in the same frequency band.

Third, the disclosed invention provides transmission capability and capacity to multiple users within simultaneous non-interfering multiple waveforms.

Fourth, the disclosed invention enables a variety of voice, audio, data, image and compressed video services primarily to mobile users heretofore unavailable.

### Preferred & Alternative Embodiments

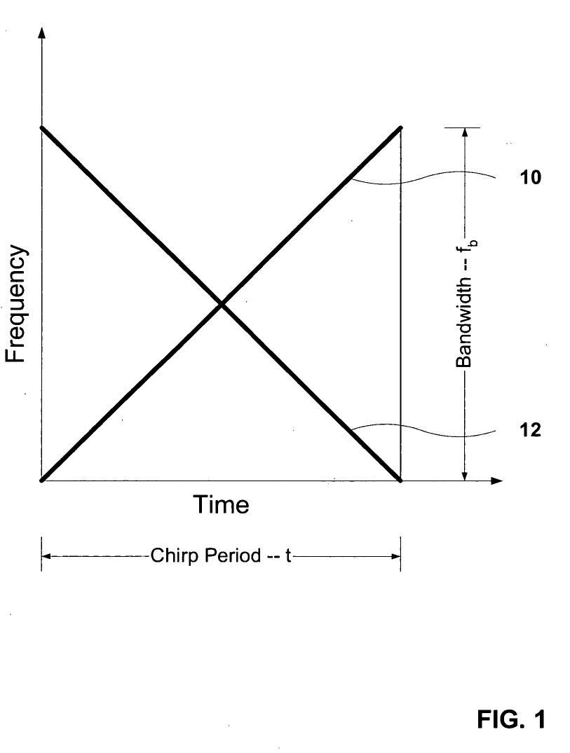

FIG. 1 shows a linear frequency up-chirp 10 and a linear frequency down-chirp 12. These chirps are defined by their bandwidth (“f_{b}”) and chirp period (“t”)

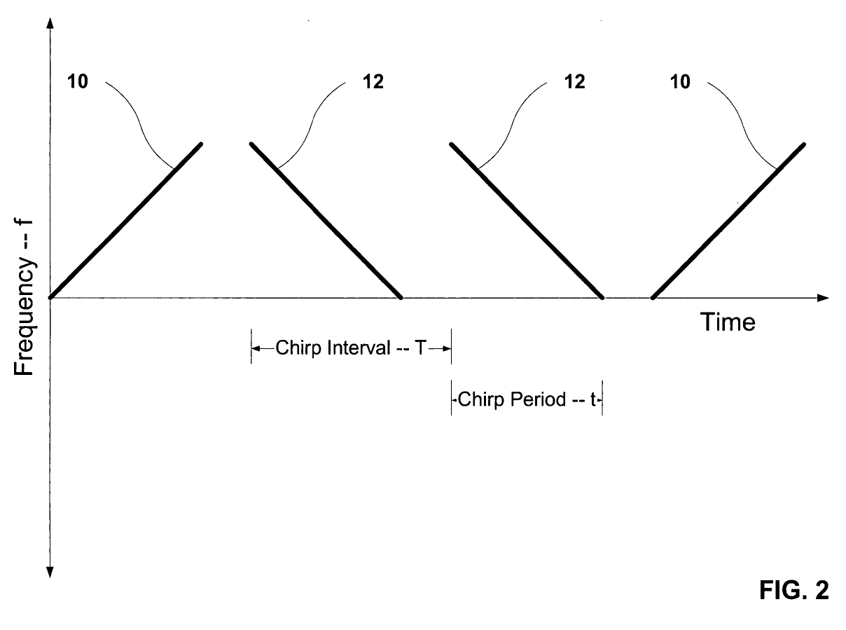

FIG. 2 shows a progression of linear frequency up-chirps 10 and down-chirps 12 in time-field strength space.

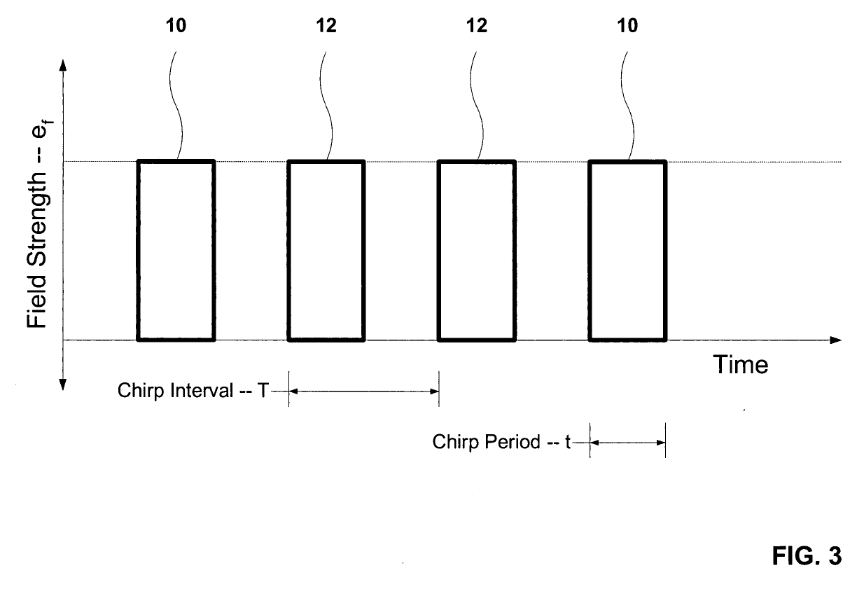

FIG. 3 shows a progression of linear frequency up-chirps 10 and down-chirps 12 in time-field strength space.

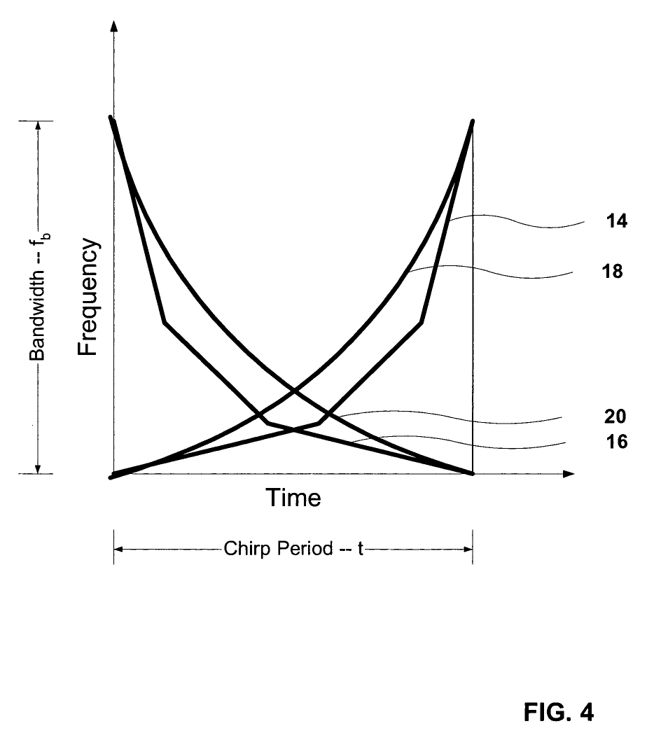

FIG. 4 illustrates non-linear frequency chirps; a linear segment frequency up-chirp 14; a linear segment frequency down-chirp 16; a curvilinear up-chirp 18; and a curvilinear down-chirp 20.

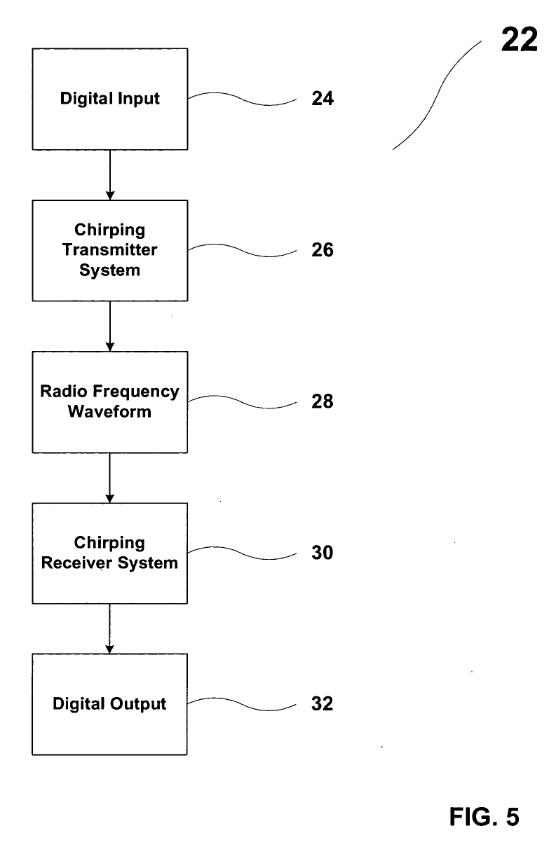

FIG. 5 shows a functional block diagram of the disclosed invention 22, the Chirping Digital Wireless System. A digital input 24 is fed to a chirping transmitter system 26 that generates the chirping radio frequency (“RF”) waveform 28. The transmitted chirping radio frequency waveform 28 is received by a chirping receiver system 30 which generates a digital output 32 that recreates the digital input 24.

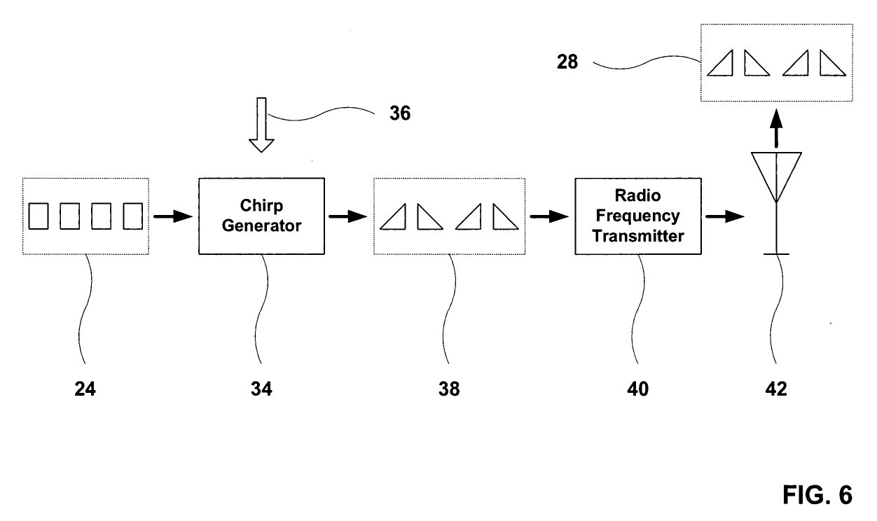

FIG. 6 shows a functional block diagram of a chirping transmitter system 26. A digital input 24 is fed to a chirp generator 34. An example of a chirp generator is a Qualcomm Incorporated Q2368 Direct Digital Synthesizer (“DDS”). However, any chirp generator may be used. A control input 36 defines the form of the chirp, its total bandwidth (f_{b}), chirp period (t) and chirp interval (T). The output of the chirp generator 34 is a series of chirps 38 having a uniform field strength (“e_{f}”), total chirp bandwidth (f_{b}), chirp period (t) and chirp interval (T). The chirp output 38 is fed to a radio frequency transmitter 40 and antenna system 42. The radio frequency transmitter 40 may be a broadband or a multi-channel transmitter. The RF output 28 comprises the wireless waveform.

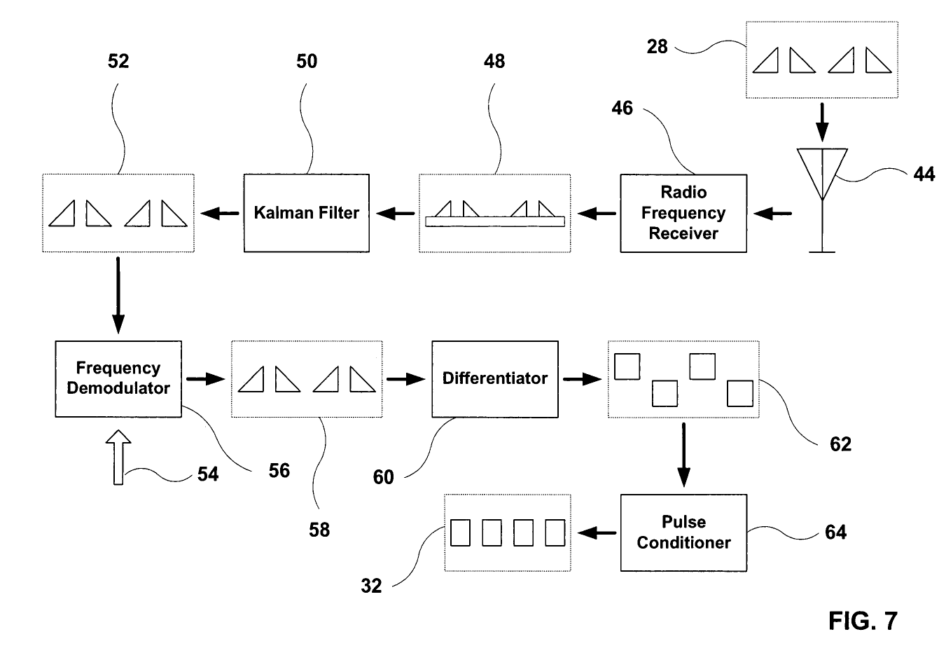

FIG. 7 shows a functional block diagram of a chirping receiver system 30. The chirping RF waveform 28 is received by an antenna 44 and RF receiver 46. The radio frequency receiver 46 may be a broadband receiver or a multi-channel receiver. The received RF input waveform 48 comprises both the RF output waveform 28 as well as RF noise resulting from the wireless transmission. The RF noise is removed from the RF input 48 using a Kahlman filter 50 resulting in a filtered RF input waveform 52. The filtered RF input waveform 52 is demodulated against a reference frequency 54 by a frequency demodulator 56. The result is an intermediate frequency (“IF”) input waveform 58 that is fed to a differentiator 60 to generate IF pulses 62 that correlate with input chirps. The IF pulses 62 are conditioned 64, that is, conformed to square wave, to yield the digital output 32.

The disclosed invention is particularly advantageous in frequency bands in which the allowed power levels are specified per frequency interval.

A further advantage of the present invention is the ability to dynamically allocate services.

A further advantage of the disclosed invention is that the same digital input 24 can be simultaneously impressed on multiple RF frequencies without interfering with the information content of the digital data.

A further advantage of the disclosed invention is that transmission to different users may be combined in a single waveform 28 by using different chirp modes 10-20.

A further advantage of the disclosed invention is that alternative chirp modes 10-20 may be used to define binary, alphanumeric and/or special characters.

A preferred embodiment of the disclosed invention 22 utilizes linear frequency chirps 10, 12.

The present invention encompasses methods and apparatus to enable efficient high bandwidth digital wireless communications. The disclosed invention can be used to provide a variety of interactive information and data services, including voice, audio, data, image and compressed video to mobile users, and also to fixed users. The disclosed invention responds to increasing mobility and demands for real-time information.

### Conclusion

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for a digital wireless communications system that have been disclosed above are intended to educate the reader about preferred embodiments of the invention, and are not intended to constrain the limits of the invention or the scope of Claims. The List of Reference Characters which follow is intended to provide the reader with a convenient means of identifying elements of the invention in the Specification and Drawings. This list is not intended to delineate or narrow the scope of the Claims.

### List of Reference Characters

10 Linear Frequency Up-Chirp
12 Linear Frequency Down-Chirp
14 Linear Segment Frequency Up-Chirp
16 Linear Segment Frequency Down-Chirp
18 Curvilinear Frequency Up-Chirp
20 Curvilinear Frequency Down-Chirp
22 Chirping Digital Wireless System
24 Digital Input
26 Chirping Transmitter
28 Chirping Radio Frequency Waveform
30 Chirping Receiver
32 Digital Output
34 Chirp Generator
36 Chirp Generator Control Input
38 Chirp Output
40 Radio Frequency Transmitter
42 Transmit Antenna
44 Receive Antenna
46 Radio Frequency Receiver
48 Received Radio Frequency Input Waveform
50 Kahlman Filter
52 Filtered Radio Frequency Input Waveform
54 Intermediate Reference Frequency
56 Frequency Demodulator
58 Intermediate Frequency Input Waveform
60 Differentiator
62 Intermediate Frequency Pulses
64 Pulse Conditioner

1. An apparatus comprising:
a chirp transmission means for generating and emanating a plurality of chirps; said plurality of chirps each conveying an element of information; and
a chirp reception means for receiving said plurality of chirps without the need for tuning to a carrier waveform;
said chirp reception means including a switch means for identifying each of said plurality of chirps;
said chirp reception means also including a conversion means for extracting information from said plurality of chirps.

2. An apparatus as claimed in claim 1, in which each of said plurality of chirps is a linear frequency chirp (10,12).

3. An apparatus as claimed in claim 1, in which each of said plurality of chirps is a non-linear frequency chirp (14-20).

4. An apparatus as recited in claim 1, in which said information is digital data.

5. An apparatus as recited in claim 1, in which said information is a voice signal.

6. An apparatus as recited in claim 1, in which said information is an audio signal.

7. An apparatus as recited in claim 1, in which said information is video signal.

8. A propagated signal comprising:
a plurality of chirps;
said plurality of chirps each conveying an element of information as characterized by the slope of one portion of each of said plurality of chirps;
said plurality chirps being capable of being received without the need for tuning to a carrier waveform.

9. A method comprising the steps of:
generating a plurality of chirps; each of said plurality of chirps having a characteristic slope portion;
transmitting said plurality of chirps without a carrier signal;
receiving said plurality of chirps without tuning to a carrier signal; and
extracting information from said plurality of chirps by reading said characteristic slope portion of each chirp.

10. An apparatus as recited in claim 1, in which allowed power levels are specified per frequency interval.

11. An apparatus as claimed in claim 1, in which services are dynamically allocated.

12. An apparatus as claimed in claim 1, in which the same digital input is simultaneously impressed on multiple RF frequencies without interfering with the information content of the digital data.

13. An apparatus as claimed in claim 1, in which transmission to different users may be combined in a single waveform by using different chirp modes.

14. An apparatus as claimed in claim 1, in which alternative chirp modes are used to define binary characters.

15. An apparatus as claimed in claim 1, in which alternative chirp modes are used to define alphanumeric characters.

16. An apparatus as claimed in claim 1, in which alternative chirp modes are used to define special characters.
